(19) United States
(12) Patent Application Publication
(10) Pub. No.: US 2023/0233300 A1
(43) Pub. Date: Jul. 27, 2023

(54) Oral Hygiene Apparatus and Method of Cleaning

(71) Applicant: MYYJEB LLC, BROOKSHIRE, TX (US)

(72) Inventor: Oluwasegun Akinsola Jebutu, Brookshire, TX (US)

(21) Appl. No.: 17/583,397

(22) Filed: Jan. 25, 2022

(51) Int. Cl. A61C 17/22; A61C 17/032

(52) U.S. Cl. CPC A61C 17/222; A61C 17/221; A61C 17/225; A61C 17/032

(57) ABSTRACT

Embodiments presented provide for an oral hygiene apparatus and method of cleaning such that a consumer may effectively clean dental apparatus with a water based solution to prevent recontamination of the oral cavity.

### CROSS-REFERENCE TO RELATED APPLICATIONS

None.

### FIELD OF THE DISCLOSURE

Aspects of the disclosure relate to an oral hygiene apparatus. More specifically, aspects of the disclosure relate to an oral hygiene apparatus and method of cleaning the oral hygiene apparatus.

### BACKGROUND

Oral hygiene is an important function in daily society. As time progresses, scientists have determined that many diseases and medical maladies originate or have a significant connection to the oral hygiene of an individual. In some instances, the medical maladies may be localized, such as the evidence of cavities in teeth of an individual. More recently, however, much more serious maladies have been connected, at least in part, to oral hygiene. As a non-limiting example, evidence has been uncovered that dementia in elderly patients may have connections to overall oral health.

As oral hygiene is important, manufacturers and producers have developed many different types of products that an individual or a medical professional can use to improve oral health. Conventional apparatus may include a standard toothbrush, floss, water cleaning apparatus and mouthwash. Other conventional apparatus are used by a medical professional such as dental scraping devices, high strength oral anti-bacterial rinses and rotary brushes. Other, more exotic devices may include whitening creams and pastes, infra-red generators and laser-based tools.

One important aspect of oral hygiene is to achieve a maximum amount of cleaning possible on a daily basis. Reliance on medical professionals, while commonplace, only begins a process to overall oral health. Commonly, individuals who go to the dentist, for example, make an appointment once every six (6) months. It is understood that after attending the dentist, the degree of cleanliness is generally better than, for example, after three months after the last dental professional visit. To achieve a maximum amount of cleanliness, it is desired for a person to have good oral health at all times, instead of just after a dentist visit.

There has been an abundance of devices, toothpastes and mouthwashes that have been commercialized that try to allow the average consumer some modicum of oral health on a daily basis. Many of the devices, however, are difficult to clean effectively. Reuse of a device that is not properly cleaned allows for the transference of bacteria and other foreign materials into the oral cavity of a person. Such “reinfection” or “recontamination” is extremely common among the general populace and thus the overall oral health of an individual is compromised on a daily basis.

Referring to FIG. 1, a conventional toothbrush 100 is illustrated. The conventional toothbrush 100 provides a handle 102, a brush head 106 and bristles 104. The bristles 104 are arranged in bunches and inserted into the brush head 106. Referring to FIG. 2, the conventional toothbrush 100 is shown with the bristles 104 inserted into the body of the brush head 106. The number of bristles 104 may vary according to different configurations. Generally, however, the number of bristles 104 can exceed over a hundred for each brush head 106. The spacing between each of the bristles 104, therefore, is close. The bristles 104 may be configured wherein they are inserted into a depression 108. The closeness of the spacing causes a retention of water and material between the bristles 104 through capillary action. An example of capillary action is illustrated in FIG. 3. In this FIG., spaces 300 between solid surfaces 302 are constrained and, through capillary action, water and material are retained in the matrix of solid surfaces 302. Such capillary action is present between the bristles 104 illustrated in FIGS. 1 and 2.

There is a need to provide an apparatus and methods used in oral hygiene care that is easier to operate than conventional apparatus and methods.

There is a further need to provide an apparatus and methods used in oral hygiene care that do not have the drawbacks discussed above, such as reinfection or recontamination.

There is a still further need to reduce economic costs associated with oral care operations and apparatus described above with conventional tools.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In another example embodiment, an apparatus is disclosed. The apparatus may comprise a high-pressure fluid conduit with a first end and a second end and a multi-jet high pressure nozzle. The apparatus may also comprise at least one valve configured to be attached to a faucet, the at least one valve configured to transport water from the faucet to the first end of the high-pressure fluid conduit. The apparatus may also comprise a handle configured to connect to the second end of the high-pressure fluid conduit and configured to transport fluid from a connection at the second end of the high pressure fluid conduit to the multi-jet high pressure nozzle.

In another example embodiment, an apparatus is disclosed. The apparatus may comprise a high-pressure fluid conduit with a first end and a second end and at least one valve configured to be attached to a faucet, the at least one valve configured to transport water from the faucet to the first end of the high-pressure fluid conduit. The apparatus may also comprise a body defining an interior volume, at least one nozzle placed within the interior volume, the body configured to connect to the second end of the high-pressure fluid conduit and configured to transport fluid from a connection at the second end of the high-pressure fluid conduit to each of the at least one nozzles.

In another example embodiment, a method may be performed. The method may comprise connecting a control valve to a water source and turning on the water source to establish a fluid flow through the control valve. The method may also comprise transmitting the fluid flow through a high-pressure conduit to a multi-jet high-pressure nozzle. The method may also comprise expelling the fluid flow through the multi-jet high-pressure nozzle and impacting an end of a toothbrush with the fluid flow.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 is a depiction of a conventional toothbrush.

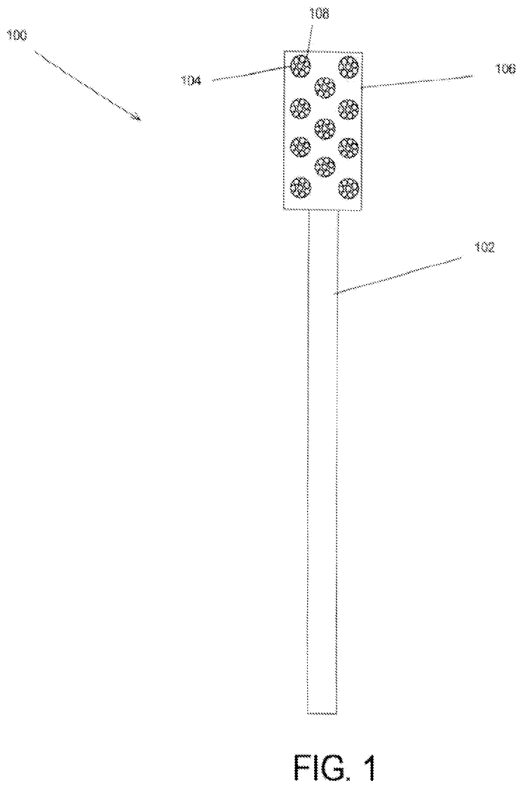

FIG. 2 is a side view of the toothbrush of FIG. 1.

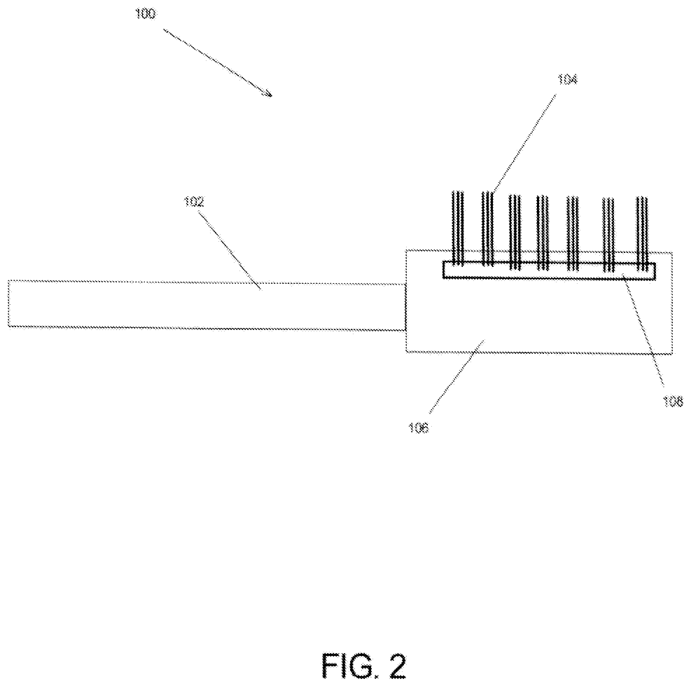

FIG. 3 is an enlarged view of capillary forces acting in between solid surfaces, such as bristles in a conventional toothbrush, as depicted in FIG. 1.

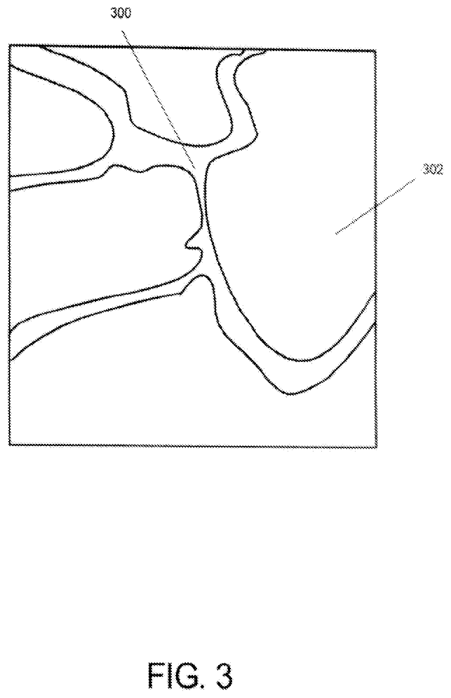

FIG. 4 is a view of an oral hygiene apparatus in accordance with one example embodiment of the disclosure.

FIG. 5 is a method flow diagram of activities performed during cleaning process in one example embodiment of the disclosure.

FIG. 6 is a hand-held oral hygiene apparatus in accordance with one example embodiment of the disclosure.

FIG. 7 is a method of cleaning a toothbrush with a hand-held oral hygiene apparatus in accordance with one example embodiment of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure provide for an apparatus and method that will allow a common individuals to be able to effectively clean a dental apparatus, such as a tooth brush, without the possibility of recontamination or reinfection of the oral cavity. As will be known by the common user, toothbrushes contain tightly packed bristles that are held in place by a head of a toothbrush. These tightly packed bristles may be formed in different geometric shapes to allow for different cleaning profiles. Commonly, toothbrush manufacturers attempt to allow for a tightly spaced filament to be anchored at the base and joined with other filaments, usually in a round overall attachment point at the toothbrush head. Filaments are generally made with some flexibility to prevent the average individual from harming their gums and the surface of the teeth. Because the filaments are tightly packed, the spaces between the filaments is quite small. Foreign materials and even toothpaste may clog the spaces between the filaments and remain lodged with the head of the toothbrush for extended periods of time.

To date, consumers ignore the accumulation of material that happens over time. Some consumers may take a more proactive approach and dispose of the toothbrush to start anew. Such actions, however, are wasteful as repeatedly purchasing a toothbrush can be expensive and produce an unnecessary waste stream.

Aspects of the disclosure provide for the ability to use a conventional water faucet to effectively clean a toothbrush, for example, in a cost effective and safe way.

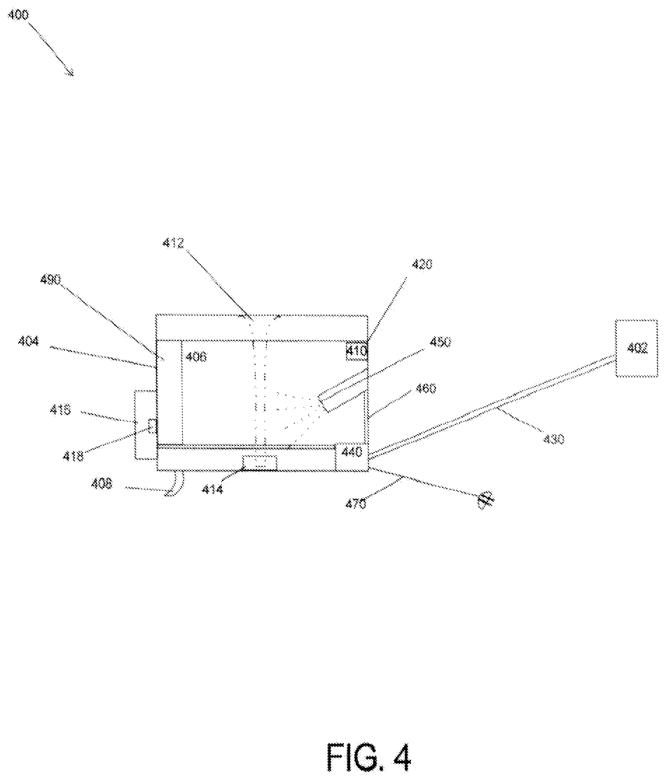

Referring to FIG. 4, an oral hygiene apparatus 400 is illustrated. The oral hygiene apparatus 400 allows for a consumer to effectively clean a toothbrush, for example, ridding the toothbrush of unwanted contamination. In one embodiment, the toothbrush may be a conventional toothbrush. In other embodiments, the toothbrush may be an electronic toothbrush. Such electronic toothbrushes may have individually rotating bunches of bristles or may be actuated through vibration. In other embodiments, a specialized toothbrush may be used, wherein the bristles are not as tightly packed, reducing potential capillary action.

In embodiments, the oral hygiene apparatus 400 uses water to clean the toothbrush. The water is supplied from a faucet at normal water pressure found in a home. Such water pressure is usually between 25 pounds per square inch to 90 pounds per square inch. Such water pressures, however, are generally ineffective to dislodge materials stuck within the bristles and brush head. The oral hygiene apparatus 400 is configured such that water pressure is accepted from a household source at standard pressures and then pressurized through a pump and/or nozzle setting to higher pressures. The higher pressure is then sprayed upon the bristles to dislodge fluids and solids trapped within the brush head. Although disclosed as using water, other configurations are possible. In other configurations, a disinfectant may be mixed with the water and injected on to the bristles and brush head. In embodiments, the disinfectant may be, for example, a mouth wash solution. In embodiments, the oral hygiene apparatus 400 may allow for the disinfectant to be directly obtained from a bottle containing the disinfectant. In other embodiments, the disinfectant may be directly poured into the oral hygiene apparatus 400.

The apparatus 400 is configured with an attachment piece 402 that connects the apparatus 400 to a faucet. As will be understood, different attachment pieces 402 may be used to connect to different faucet types, allowing for the apparatus 400 to be used on multiple types of faucets. Such multiple attachment capability may allow the apparatus 400 to be portable so that an individual may take the apparatus 400 in a travel pack or suitcase while away from home.

The apparatus 400 is configured with a body 404 that defines an internal cavity 406. The internal cavity is provided with a drain such that water that enters the internal cavity, as delivered by the attachment piece 402, may exit and drain the apparatus 400. A discharge 408 from the apparatus 400 allows water and/or disinfectant to exit the apparatus 400 such that the fluids will not contaminate the toothbrush. The discharge 408 is configured such that fluids exit the apparatus 400 are a low velocity to prevent possible harm to the user. In embodiments, the discharge 408 may be configured to maintain the fluids used by the apparatus 400 until the end of the cleaning cycle. In embodiments, the body 404 is configured with a sensor 410 such that if the apparatus lid 420 is opened, the cleaning cycle is stopped. This may be configured through an interrupt switch that cuts electricity to a pump used to increase the water pressure or a switch or valve associated with nozzle orifices. Such interruption capability may be used as a safety device to prevent a user from being sprayed with water and/or disinfectant at high pressures. A high-pressure fluid conduit 430 is provided to channel water from the attachment piece 402 to the body 404. In embodiments of the disclosure, a separate pump 440 may be provided within the body 404 to increase the water pressure as needed for cleaning activities. Fluid be transferred from the pump 440 through a conduit 460 to a multi-orifice nozzle set or series 450. Electricity for an embodiment that contains a separate pump 440 may be provided by an electrical connection 470 if required.

Spraying of the water and/or disinfectant may be accomplished through a nozzle or a series of nozzles 450 configured to spray the fluids. In one embodiment, the body 404 is configured with a port 412 that allows the toothbrush to maintain a predefined orientation. The nozzle 460 or series of nozzles are pointed at different sections where the toothbrush head will be located, thereby allowing the fluid to be inundated with water. In embodiments, a series of nozzles 450 is provided, allowing for high pressure cleaning of the toothbrush around a 360 degree rotational axis. In another embodiment, a single nozzle may be provided and a separate rotation device provided to turn the toothbrush at a 360 degree rotational axis. The separate rotation device 414 may be an electric motor to allow for spinning. In further embodiments, the rotation device 414 speed may be controlled to allow for rotation before, during and after fluids are injected on to the brush head. As will be further understood, the rotation device 414 may be configured as a drying device, wherein a centripetal acceleration is imparted on to the brush head through rotation, thereby a creating a force greater than the capillary action keeping the water within the bristles and brush head, thereby allowing for ejection of water. In embodiments, mouthwash may be poured into retainer 490 fluidly connected with the nozzle 450 to administer disinfectant, if needed, within the body 402.

Other configurations for drying the toothbrush may also include providing a vibration mechanism to allow for vibratory cleaning of the toothbrush head. Still further embodiments may allow the internal cavity 406 to be heated by a heater, allowing for drying of the toothbrush. In all of the drying actions described above, the amounts of time and intensity of the drying may be varied through a user interacting with the mechanism. User interactions may be through a touchscreen 416 that is connected to a central processing unit 418 that actuates different components of the apparatus 400. As will be understood, the drying process is sufficient to dry the components, but not damage the structure of the toothbrush.

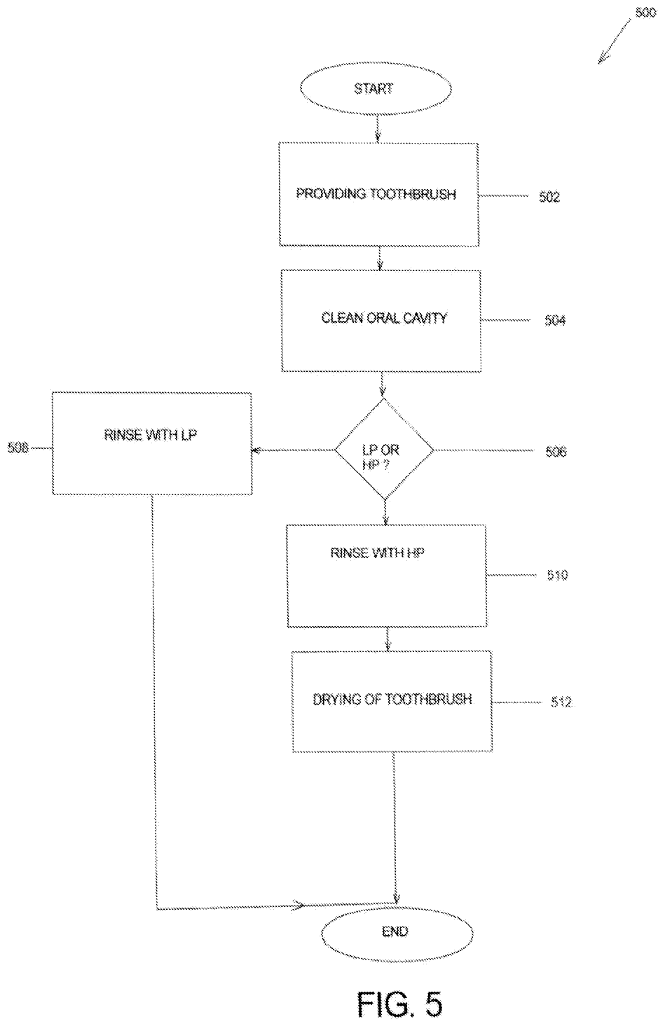

Referring to FIG. 5, a method 500 of performing a cleaning of an oral hygiene apparatus is illustrated. The method 500 starts at 502 with a user providing a tooth brush. At 504, during oral cavity cleaning foam forms in the mouth and mixes with germs, fluids and other materials in the oral cavity of a user. At 506, the user has two different choices that can be made, low pressure rinse and high pressure rinse. If the user chooses low pressure rinse, the user can at 608, use a low-pressure rinse and the result may be a contaminated toothbrush. If, at 506, the user chooses a high-pressure rinse, an oral hygiene apparatus, as described in the figures above, may be used to remove germs, materials and fluids from the toothbrush at 510. With the toothbrush now cleaned, at 610, the toothbrush may be stored and the method returned back to step 500. An optional drying of the toothbrush may occur at 612. This drying may be through heat, evaporation or vibration. Other types of drying may also include cool drying and combinations of the drying types described above.

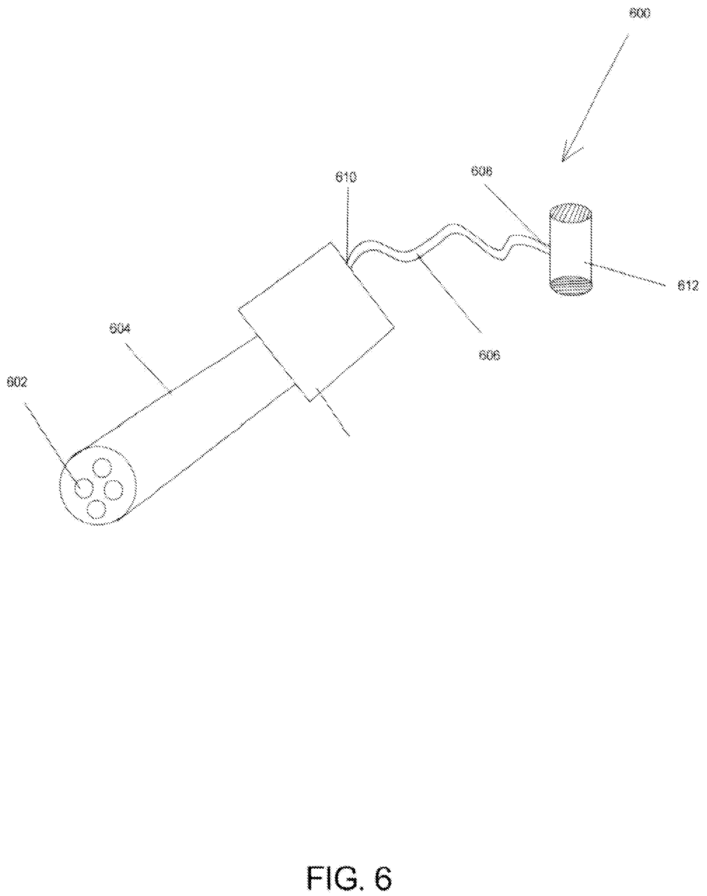

Referring to FIG. 6, a hand held oral hygiene apparatus 600 is illustrated. In this embodiment, the apparatus 600 is a hand-held unit that connect directly to a water faucet. As will be understandable, the oral hygiene apparatus 600 may produce a water/fluid stream that is greater than 100 pounds per square inch, therefore such a product would be used by an adult. In FIG. 6, a multi-jet high pressure nozzle 602 is used to expel water onto a toothbrush head to remove materials attached to the head. In the illustrated embodiment, four (4) nozzles are provided. Other configurations are possible, wherein a greater or lesser number of nozzles may be provided. The high-pressure nozzle 602 is attached to a handle 604 that allows for gripping of the apparatus 600 during use. The handle 604 may have a foldable/built in stand that allows the handle to be rested after use. A high-pressure fluid conduit 606 is provided to attach to the handle 604 to allow fluid traveling at high pressures to be transported from a first end 608 to a second end 610. As will be understood, the second end 610 is configured to be attached to the handle 604 while the first end 608 is arranged to be attached to a connector valve 612 that attaches to a water faucet. In the illustrated embodiment, the connector valve 614 may be a fixed unit that is screw attached to the faucet. Other types of connections between the faucet and the connector valve 612 are possible and therefore the illustration and description should not be considered limiting. If greater pressures are needed, the connector valve 612 may be configured as a set of valves. In other example embodiments, a pump may be added to increase the water pressure as the fluid enters the high-pressure fluid conduit 606. In instances with a pump, electrical protection may be provided to prevent the user from accidentally coming in contact with electricity and water at the same time.

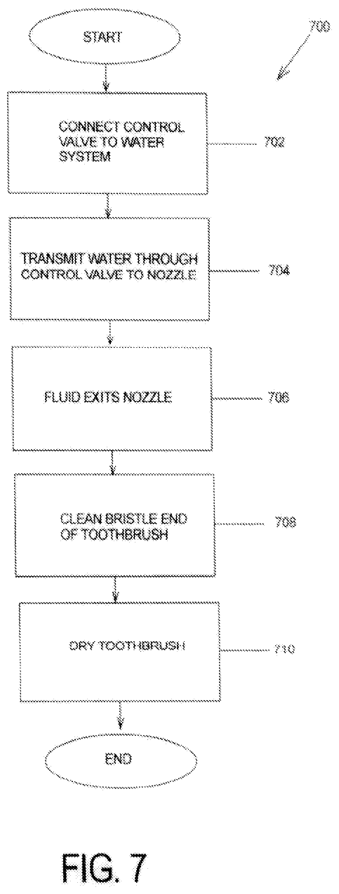

Referring to FIG. 7, a method 700 of cleaning an oral hygiene apparatus with a hand-held unit is illustrated. In one example embodiment, the device cleaned is a standard toothbrush. Other types of toothbrushes may be cleaned as well with this method 700. A control valve is connected to a water source at 702. The control valve may be a single valve or a series of valves. The user may then turn on the water source producing water that flows through the single valve or series of valves to a connected high pressure conduit, as illustrated in FIG. 6. At 704, the fluid may exit the high pressure fluid conduit to enter a handle and enter a multi-jet high pressure nozzle. At 706, the water may exit a multi-jet high pressure nozzle. The water, at 708, impacts the bristle end of a toothbrush, thereby cleaning the bristle end of the toothbrush from contaminants. At 710, the method may also include drying of the toothbrush, through various methodologies, including heating the toothbrush head or vibrating the toothbrush head. As will be understood, the fluid may be water, a disinfectant, or a combination of such fluids to aid in the claiming the bristle end of the toothbrush head.

Embodiments presented herein provide an apparatus that uses conventional water faucets to effectively clean a toothbrush. Such cleaning is much more advanced and effective than simple hand washing of the toothbrush. Embodiments also provide for a method of oral hygiene care that is easier and more effective than conventional apparatus and methods. To date, such effective provisions for oral hygiene care have not been provided and there is a long felt need for such effective cleaning technology.

Embodiments described herein provide the advantages and satisfy the long felt needs described above without the significant drawbacks such as reinfection or recontamination.

Embodiments also provide for a reduction in the overall oral hygiene care of the common individual. With the greater cleaning ability, individuals are less prone to more expensive and required dental care that can be economically challenging. The apparatus and methods described herein also further reduce economic costs associated with oral care operations and apparatus described above with conventional tools by preventing the unwanted and premature disposal of dental apparatus.

In another example embodiment, an apparatus is disclosed. The apparatus may comprise a high-pressure fluid conduit with a first end and a second end and a multi-jet high pressure nozzle. The apparatus may also comprise at least one valve configured to be attached to a faucet, the at least one valve configured to transport water from the faucet to the first end of the high-pressure fluid conduit. The apparatus may also comprise a handle configured to connect to the second end of the high-pressure fluid conduit and configured to transport fluid from a connection at the second end of the high pressure fluid conduit to the multi-jet high pressure nozzle.

In another example embodiment, the apparatus may be configured wherein the nozzle is detachable.

In another example embodiment, the apparatus may be configured wherein the nozzle has four jets configured to eject water on to a surface.

In another example embodiment, the apparatus may be configured wherein the handle is configured with a stand.

In another example embodiment, the apparatus may be configured wherein the high-pressure fluid conduit is flexible.

In another example embodiment, the apparatus may be configured wherein the apparatus is configured to be portable.

In another example embodiment, an apparatus is disclosed. The apparatus may comprise a high-pressure fluid conduit with a first end and a second end and at least one valve configured to be attached to a faucet, the at least one valve configured to transport water from the faucet to the first end of the high-pressure fluid conduit. The apparatus may also comprise a body defining an interior volume, at least one nozzle placed within the interior volume, the body configured to connect to the second end of the high-pressure fluid conduit and configured to transport fluid from a connection at the second end of the high-pressure fluid conduit to each of the at least one nozzles.

In another example embodiment, the apparatus may further comprise a drying apparatus configured in the interior volume.

In another example embodiment, the apparatus may be configured wherein the drying apparatus is one of a vibration generating device and a heat source.

In another example embodiment, the apparatus may be configured wherein the body is configured with a port for placement of a toothbrush.

In another example embodiment, the apparatus may be further configured wherein the body is configured with a lid.

In another example embodiment, the apparatus may further comprise a sensor connected to the lid wherein the water is not ejected from the at least one nozzle under actuation of the sensor.

In another example embodiment, the apparatus may further comprise a pump placed within the volume, wherein the pump is configured to increase a fluid pressure of the water from the high-pressure fluid conduit.

In another example embodiment, the apparatus may further comprise a retainer, configured to hold a fluid and a fluid connection configured to deliver the fluid from the retainer to the at least one nozzle.

In another example embodiment, a method may be performed. The method may comprise connecting a control valve to a water source and turning on the water source to establish a fluid flow through the control valve. The method may also comprise transmitting the fluid flow through a high-pressure conduit to a multi-jet high-pressure nozzle. The method may also comprise expelling the fluid flow through the multi-jet high-pressure nozzle and impacting an end of a toothbrush with the fluid flow.

In another example embodiment, the method may be performed wherein the control valve is a series of valves.

In another example embodiment, the method may be performed wherein the method further comprises drying the toothbrush.

In another example embodiment, the method may be performed wherein the drying of the toothbrush is through a heat source.

In another example embodiment, the method may be performed wherein the drying of the toothbrush is through a vibration source.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. An apparatus, comprising:
a high-pressure fluid conduit with a first end and a second end;
a multi-jet high pressure nozzle;
at least one valve configured to be attached to a faucet, the at least one valve configured to transport water from the faucet to the first end of the high-pressure fluid conduit; and
a handle configured to connect to the second end of the high-pressure fluid conduit and configured to transport fluid from a connection at the second end of the high pressure fluid conduit to the multi-jet high pressure nozzle.

2. The apparatus according to claim 1, wherein the nozzle is detachable.

3. The apparatus according to claim 1, wherein the nozzle has four jets configured to eject water on to a surface.

4. The apparatus according to claim 1, wherein the handle is configured with a stand.

5. The apparatus according to claim 1, wherein the high-pressure fluid conduit is flexible.

6. The apparatus according to claim 1, wherein the apparatus is configured to be portable.

7. An apparatus, comprising:
a high-pressure fluid conduit with a first end and a second end;
at least one valve configured to be attached to a faucet, the at least one valve configured to transport water from the faucet to the first end of the high-pressure fluid conduit; and
a body defining an interior volume, at least one nozzle placed within the interior volume, the body configured to connect to the second end of the high-pressure fluid conduit and configured to transport fluid from a connection at the second end of the high-pressure fluid conduit to each of the at least one nozzles.

8. The apparatus according to claim 1, further comprising:
a drying apparatus configured in the interior volume.

9. The apparatus according to claim 8, wherein the drying apparatus is one of a vibration generating device and a heat source.

10. The apparatus according to claim 7, wherein the body is configured with a port for placement of a toothbrush.

11. The apparatus according to claim 7, wherein the body is configured with a lid.

12. The apparatus according to claim 11, further comprising:
a sensor connected to the lid wherein the water is not ejected from the at least one nozzle under actuation of the sensor.

13. The apparatus according to claim 7, further comprising:
a pump placed within the volume, wherein the pump is configured to increase a fluid pressure of the water from the high-pressure fluid conduit.

14. The apparatus according to claim 7, further comprising:
a retainer, configured to hold a fluid; and
a fluid connection configured to deliver the fluid from the retainer to the at least one nozzle.

15. A method, comprising:
connecting a control valve to a water source;
turning on the water source to establish a fluid flow through the control valve;
transmitting the fluid flow through a high-pressure conduit to a multi-jet high-pressure nozzle;
expelling the fluid flow through the multi-jet high-pressure nozzle; and
impacting an end of a toothbrush with the fluid flow.

16. The method according to claim 15, wherein the control valve is a series of valves.

17. The method according to claim 15, further comprising:
drying the toothbrush.

18. The method according to claim 17, wherein the drying of the toothbrush is through a heat source.

19. The method according to claim 17, wherein the drying of the toothbrush is through a vibration source.
